(19) United States
(12) Patent Application Publication
(10) Pub. No.: US 2024/0264275 A1
(43) Pub. Date: Aug. 8, 2024

(54) METHOD AND APPARATUS FOR RECOGNIZING AN OBJECT

(71) Applicants: HYUNDAI MOTOR COMPANY, Seoul (KR); KIA CORPORATION, Seoul (KR); HANDONG GLOBAL UNIVERSITY INDUSTRY-ACADEMIC COOPERATION FOUNDATION, Pohang-si (KR)

(72) Inventors: Seul Ki Han, Seoul (KR); Won Sang Ra, Pohang-si (KR); Hyung Chan Cho, Pohang-si (KR); Chan Seok Lee, Pohang-si (KR)

(73) Assignees: HYUNDAI MOTOR COMPANY, Seoul (KR); KIA CORPORATION, Seoul (KR); HANDONG GLOBAL UNIVERSITY INDUSTRY-ACADEMIC COOPERATION FOUNDATION, Pohang-si (KR)

(21) Appl. No.: 18/425,603

(22) Filed: Jan. 29, 2024

(30) Foreign Application Priority Data
Feb. 6, 2023 (KR) 10-2023-0015662

(51) Int. Cl. G01S 7/41; G01S 7/40

(52) U.S. Cl. CPC G01S 7/412; G01S 7/4052

(57) ABSTRACT

A method for recognizing an object comprises storing a reference reflection characteristic for each of classes based on modeling radar reflection signal data for each of objects corresponding to each of the classes, determining, among the classes, a class of a reference reflection characteristic of a high similarity with a reflection characteristic of received signal data transmitted from a radar, and identifying a target object of the received signal data based on the determined class and outputting information of the target object.

The present application claims priority to Korean Patent Application No. 10-2023-0015662, filed on Feb. 6, 2023, the entire contents of which is incorporated herein by reference in its entirely.

### TECHNICAL FIELD

The present disclosure relates to a method and an apparatus for recognizing the type of a moving object.

### BACKGROUND

A high-resolution radar mounted on a vehicle is robust to adverse weather and night conditions compared to the camera and the LiDAR, and may have a wide detection area. In addition, the high-resolution radar may provide a two-dimensional or three-dimensional reflected signal strength distribution with angular resolution of 1 degree. These distribution can resemble an image for an object moving around the vehicle.

In the related art, radar image processing based on deep learning technology and radar image histogram analysis technology are developed and used to identify the object moving around the vehicle by using such a high-resolution radar.

In the radar image processing, images of received signal strength for each moving object obtained by high-resolution radar for neural network learning are used. The radar image processing is similar to a YOLO algorithm mainly used for camera sensor-based object detection, and the design of the technology is relatively simple by applying the conventional camera-based object detection methodology and the like as it is.

The radar image histogram analysis technology is a technology for estimating the type of an object (e.g., a road, a bush, a vehicle) through a change in reflection characteristics according to the material of a surface from which a transmission signal of a high-resolution radar is reflected. The radar image histogram analysis technology is a technology for estimating the type of each cluster by comparing the reflection characteristic of each cluster obtained by clustering an area having similar characteristics among obtained reflection characteristics with a reflection characteristic according to the material of a pre-modeled reflection surface.

The conventional image processing has a disadvantage in that a large amount of learning data is required to increase the accuracy of the identification of a moving object due to the nature of a deep learning technique performed with a single framework from input data to the identification result of a moving object. In addition, in the conventional image processing, it is difficult to analyze the cause of the movement object identification performance due to the characteristics of an end-to-end method, and thus there is a disadvantage in that there is a limitation in maintenance and performance improvement later.

The related art radar image histogram analysis technology requires a reflection characteristic modeling process according to the material of a reflection surface, and thus, has a disadvantage in that a lot of data is required for modeling like the deep learning technology. In addition, the radar image histogram analysis technology in the related art is sensitive to a change in a signal measurement environment because it uses reception intensity information of a clustered area, and it is impossible to distinguish the types of moving objects having the same reflective surface material, for example, passenger cars and commercial cars. In addition, in the radar image histogram analysis technology according to the related art, when an area having a similar reflection characteristic is clustered, a case in which a moving object having a relatively small size is not identified by applying a morphology operation mainly used for image processing may occur.

### Summary of Disclosure

An embodiment of the present disclosure may provide an object identification method and an apparatus capable of recognizing the type of a moving object based on a distribution characteristic model of received signal intensities of radar.

According to an embodiment of the present disclosure, a method for recognizing an object comprises storing a reference reflection characteristic for each of classes based on modeling radar reflection signal data for each of objects corresponding to each of the classes, determining, among the classes, a class of a reference reflection characteristic of a high similarity with a reflection characteristic of received signal data transmitted from a radar, and identifying a target object of the received signal data based on the determined class and outputting information of the target object.

In at least one embodiment of the present disclosure, the modeling the radar reflection signal data for each of objects comprises modeling an intensity of the radar reflection signal data into a mixed normal distribution.

In at least one embodiment of the present disclosure, the intensity of the radar reflection signal data includes an intensity of the radar reflection signal on relative distance and angle plane extracted from a radar data cube generated based on Fast Fourier Transform of the radar reflection signal data.

In at least one embodiment of the present disclosure, the radar reflection signal data is generated by a radar simulation signal generator.

In at least one embodiment of the present disclosure, the classes may include one or more classes selected from a class corresponding to a two-wheeled vehicle, a class corresponding to a passenger vehicle, and a class corresponding to a commercial vehicle.

In at least one embodiment of the present disclosure, the class corresponding to the passenger vehicle and the class corresponding to the commercial vehicle may each include a class corresponding to each of predetermined object sizes.

In at least one embodiment of the present disclosure, the determining the class includes applying the received signal data to a radar reflection characteristic model and obtaining the reflection characteristic with respect to a predetermined reference distance, and determining a similarity between the reference reflection characteristic for each of the classes and the reflection characteristic of the received signal data.

In at least one embodiment of the present disclosure, The method further comprises obtaining, from the radar, information indicating a relative distance and an observation angle between the radar and the target object, wherein the obtaining the reflection characteristic with respect to the predetermined reference distance comprises: when applying the received data to the radar reflection characteristic model, applying the information indicating the relative distance and the observation angle to the radar reflection characteristic model.

In at least one embodiment of the present disclosure, obtaining the reflection characteristic with respect to the predetermined reference distance further comprises, when applying the received data to the radar reflection characteristic model, applying a predetermined radar distance and a predetermined angular resolution of the radar to the radar reflection characteristic model.

In at least one embodiment of the present disclosure, the method may further comprise obtaining detection information for determining location information of each of the objects from the radar, wherein the similarity is based on the detection information.

In at least one embodiment of the present disclosure, the determining the similarity comprises applying a weight, an average and a variance of the reflection characteristic of the received signal data and the detection information to a mixed normal distribution model to determine the similarity between the reference reflection characteristic for each of the classes and the reflection characteristic of the received signal data.

In at least one embodiment of the present disclosure, the method may further comprise determining a reference similarity for each of the classes by normalizing the similarity based on a number of the classes.

In at least one embodiment of the present disclosure, the determining the class comprises identifying one or more classes each having the reference similarity exceeding a threshold value among the classes, and identifying a class having a highest similarity among the identified one or more classes as the class of the reference reflection characteristic of the high similarity with the reflection characteristic of the received signal data transmitted from the radar.

According to an embodiment of the present disclosure, an object recognizing apparatus comprises a memory configured to store a reference reflection characteristic for each of classes based on modeling radar reflection signal data for each of objects corresponding to each of the classes, and a processor configured to determine, among the classes, a class of a reference reflection characteristic of a high similarity with a reflection characteristic of received signal data transmitted from a radar, identify a target object of the received signal data based on the determined class, and output information of the target object.

In at least one embodiment of the apparatus, the modeling the radar reflection signal data for each of objects include modeling an intensity of the radar reflection signal data into a mixed normal distribution.

In at least one embodiment of the apparatus, the intensity of the radar reflection signal data includes an intensity of the radar reflection signal on relative distance and angle plane extracted from a radar data cube generated based on Fast Fourier Transform of the radar reflection signal data.

In at least one embodiment of the apparatus, the radar reflection signal data may be generated by a radar simulation signal generator.

In at least one embodiment of the apparatus, the classes may include one or more classes selected from a class corresponding to a two-wheeled vehicle, a class corresponding to a passenger vehicle, and a class corresponding to a commercial vehicle.

In at least one embodiment of the apparatus, the processor may be further configured to obtain the reflection characteristic of the target object with respect to a predetermined reference distance by applying the received signal data to a radar reflection characteristic model, and determine a similarity between the reference reflection characteristic for each of the classes and the reflection characteristic of the received signal da.

In at least one embodiment of the apparatus, the processor is further configured to obtain information indicating a relative distance and an observation angle between the radar and the target object from the radar, and when applying the received data to the radar reflection characteristic model, the processor is configure to apply the information indicating the relative distance and the observation angle and a predetermined radar distance and a predetermined angle resolution of the radar to the radar reflection characteristic model.

The object identification method and apparatus according to an embodiment of the present disclosure may provide a high-resolution radar data modeling technique.

For example, the object identification method and apparatus according to an embodiment of the present disclosure may provide a signal processing technique of modeling a relative distance provided by a high-resolution radar and a reflected signal strength of an object defined on a Doppler plane into a mixed normal distribution.

According to the modeling technique of the present disclosure, mixed normal distribution approximation is performed in mutually non-correlated measurement spaces, thereby securing numerical stability and improving accuracy of approximation. In addition, the high-resolution radar data signal processing technology according to the present disclosure may minimize loss of reflected signal strength information that changes according to the shape of an object and a lateral angle, and at the same time, may remarkably reduce the amount of memory required for storing corresponding information in a database. Accordingly, it is possible to reduce the hardware cost of the autonomous driving system of a vehicle.

The object identification method and apparatus according to an embodiment of the present disclosure may provide a reflection characteristic model-based moving object identification technology.

For example, the object identification method and apparatus according to an embodiment of the present disclosure may provide a technique for recognizing the type of a moving object by using reflected signal strength of an object approximated by a mixed normal distribution as prior information.

Such a technology makes it possible to estimate approximate size information of an object, thereby making it possible to successfully identify a passenger vehicle, a commercial vehicle, and/or a two-wheeled vehicle, and thus it is possible to improve the performance of a vehicle collision prevention technology in a driving situation in which a plurality of moving objects exist near a vehicle.

In addition, the technology according to an embodiment of the present disclosure may have extensibility because a probabilistic evaluation is performed for each class to the measured reflected signal strength, and thus it may be fused with easily the identification results of other sensing devices such as a camera and/or LiDAR.

In addition, the technology according to an embodiment of the present disclosure may solve a problem in which it is difficult to analyze the identification performance of a conventional art using a data-based deep learning technique. More specifically, the technology according to an embodiment of the present disclosure may easily analyze the identification performance of an object and grasp the causal relationship, thereby having an advantage in improving, maintaining, and repairing the performance of the object recognizing apparatus compared to the conventional art.

### BRIEF DESCRIPTION OF THE DRAWINGS

FIG. 1 is a block diagram of a vehicle according to an embodiment of the present disclosure.

FIG. 2 is a block diagram illustrating a detailed feature of a class reflection characteristic extractor according to an embodiment of FIG. 1.

FIGS. 3A-3B show a diagram illustrating a reflection characteristic corresponding to an approximation result of a simulated reflection signal and a Gaussian mixture model of the simulated reflection signal according to an embodiment of the present disclosure.

FIGS. 4A-4C show a diagram illustrating a reflection characteristic model ring result of vehicles corresponding to a medium-sized passenger vehicle and an average reflection characteristic modeling result of the medium-sized passenger vehicle according to an embodiment of the present disclosure.

FIG. 5 is a block diagram illustrating a detailed feature of a radar and a moving object identification unit according to the embodiment of FIG. 1.

FIGS. 6A-6D show a diagram for describing the accuracy of an output of a class reflection characteristic approximation unit according to an embodiment of the present disclosure.

FIG. 7 is a flowchart illustrating an operation of an object recognizing apparatus according to an embodiment of the present disclosure.

FIG. 8 is a coordinate system defining a relative geometry between a high-resolution radar and an object to be identified.

FIGS. 9A-9D show a diagram illustrating an output result of reflection characteristics for each class according to an object identification experiment according to an embodiment of the present disclosure.

FIGS. 10A-10D show a graph showing normalized similarity for each class according to an object identification experiment.

FIGS. 11A-11B show a diagram illustrating classification performance of an object identification technology according to a conventional technology and an embodiment of the present disclosure, in a confusion matrix.

### DETAILED DESCRIPTION

Like reference numerals refer to like elements throughout the specification. The present specification does not describe all elements of the embodiments, and general contents in the technical field to which the present disclosure pertains or overlapping contents between the embodiments are omitted. The term “unit, module, or device” used in the specification may be implemented by software or hardware, and according to embodiments, a plurality of “units, modules, or devices” may be implemented as one component, or one “unit, module, or device” may include a plurality of components.

Throughout the specification, when a part is “connected” to another part, this includes not only a case of being directly connected but also a case of being indirectly connected, and the indirect connection includes being connected through a wireless communication network.

In addition, when a part “includes” a component, this means that other components may be further included, rather than excluding other components, unless specifically stated otherwise.

The terms “first”, “second”, etc. are used to distinguish one component from another, and the components are not limited by the above terms.

A singular expression includes a plural expression unless there is a clear exception in the context.

In each step, an identification code is used for convenience of description, and thus the identification code does not describe an order of each step, and each step may be performed differently from a specified order unless a specific order is clearly described in the context.

The present disclosure is to provide a method and an apparatus for recognizing an object located around a vehicle, for example, a type of a moving object, based on a reflected signal strength measurement value of a high-resolution radar.

More specifically, the present disclosure may provide a method and an apparatus for recognizing an object based on a spatial distribution characteristic model of the received signal strength of a radar, which is changed according to the shape and size of a target object to be classified (e.g., a passenger vehicle, a commercial vehicle, a two-wheeled vehicle, etc.), which is differentiated from a conventional art.

For example, the object identification method and apparatus according to an embodiment of the present disclosure may provide a technique of modeling a distribution characteristic of the received signal strength of the radar through a 3D CAD file for each type of object and a radar signal simulator, based on the fact that a spatial distribution characteristic of the received signal strength of the radar may be determined according to the shape and/or size of easily the object.

In addition, the object identification method and apparatus according to an embodiment of the present disclosure may provide a technique for recognizing the type of an object by determining a similarity between a received signal strength distribution of radar and distribution models for each type of a previously modeled object.

Hereinafter, operation principles and embodiments of the present disclosure will be described with reference to the accompanying drawings.

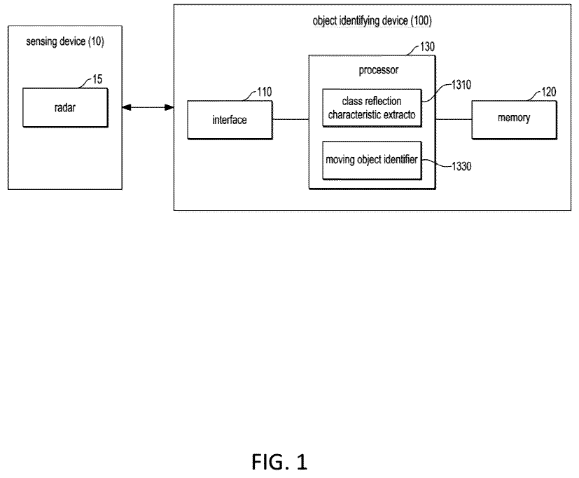

FIG. 1 is a block diagram of a vehicle according to an embodiment.

Referring to FIG. 1, a vehicle 1 may include a sensing device 10 and/or an object recognizing device 100.

The sensing device 10 may include one or more devices capable of obtaining information about an object (also referred to as a moving object) located around the vehicle 1.

The sensing device 10 may include a radar 15.

The radar 15 may detect an object around the vehicle 1.

For example, the radar 15 may include a front radar (not shown) installed in the front of the vehicle 1, a first corner radar (not shown) installed in the front right side of the vehicle 1, a second corner radar (not shown) installed in the front left side, a third corner radar (not shown) installed in the rear right side, and/or a fourth corner radar (not shown) installed in the rear left side, and the like, and may have a detection field of view toward the front, front right, front left, rear right, and/or rear left of the vehicle 1.

Meanwhile, although not shown, the sensing device 10 may further include a lidar (not shown) capable of generating lidar data, that is, a plurality of point data (also referred to as point cloud data) by emitting laser pulses toward the vicinity of the vehicle 1, and/or a camera (not shown) capable of obtaining image data of the vicinity of the vehicle 1.

The object recognizing apparatus 100 may include an interface 110, a memory 120, and/or a processor 130.

The interface 110 may transmit a command or data input from another device (e.g., the sensing device 10) of the vehicle 1 or a user to another feature element of the object recognizing apparatus 100, or may output a command or data received from another feature element of the object recognizing apparatus 100 to another device of the vehicle 1.

The interface 110 may include a communication module (not shown) to communicate with other devices of the vehicle 1.

For example, the communication module may include a communication module capable of performing communication between devices of the vehicle 1, for example, controller area network (CAN) communication and/or local interconnect network (LIN) communication, through a vehicle communication network. Further, the communication module may include a wired communication module (e.g., a power line communication module) and/or a wireless communication module (e.g., a cellular communication module, a Wi-Fi communication module, a short-range wireless communication module, and/or a global navigation satellite system (GNSS) communication module).

The memory 120 may store various data used by at least one feature element of the object recognizing apparatus 100, for example, input data and/or output data for a software program and a command related thereto.

The memory 120 may include a nonvolatile memory such as a cache, a Read Only Memory (ROM), a Programmable ROM (PROM), an Erasable Programmable ROM (EPROM), an Electrically Erasable Programmable ROM (EEPROM), and/or a flash memory, and/or a volatile memory such as a Random Access Memory (RAM).

The processor 130 (also referred to as a control circuit or a controller) may control at least one other feature element (e.g., a hardware feature element (e.g., an interface 110)) of the object recognizing apparatus 100, and/or a memory 120 and/or a software feature element (software program), and various data processing and operations may be performed.

The processor 130 may model reflection signal data obtained from the radar 15 which varies according to a shape and/or a size of an object located around the vehicle 1, for example, a moving object, as a mixed normal distribution.

The processor 130 may calculate similarities between the moving object and the modeled objects based on detection information about the moving object and the modeled reflection characteristic of each object, and identify the type of the moving object based on the similarity.

The processor 130 may include a class reflection characteristic extractor 1310 and a moving object identifier 1330.

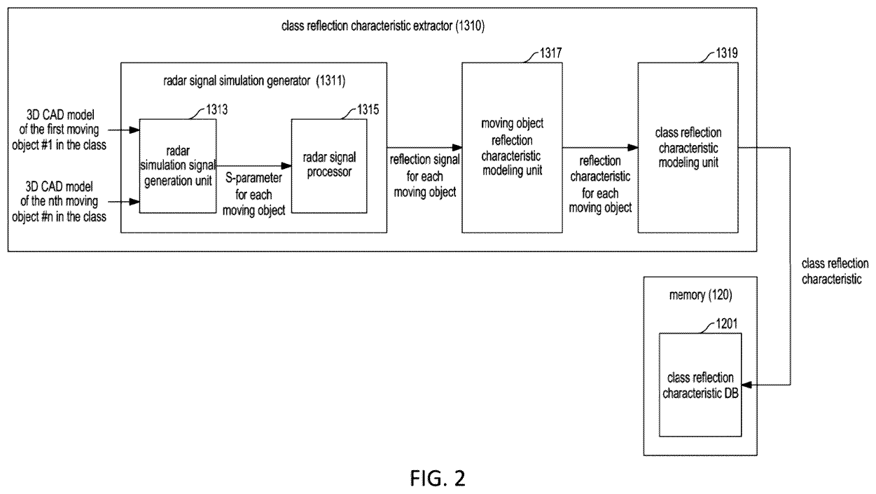

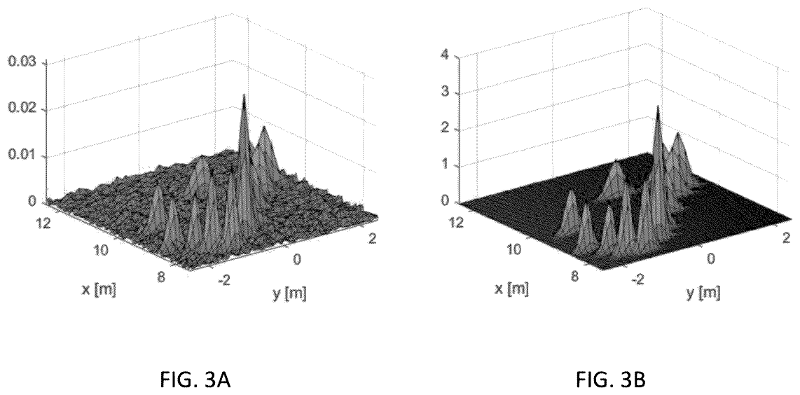

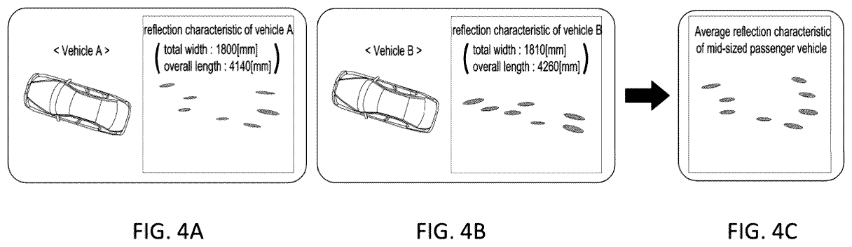

FIG. 2 is a block diagram illustrating a detailed feature of the class reflection characteristic extractor 1310 according to an embodiment of FIG. 1. FIG. 3 is a diagram illustrating a reflection characteristic corresponding to an approximation result of a simulated reflection signal data and a Gaussian Mixture Model (GMM) of the simulated reflection signal data according to an embodiment. FIG. 4 is a diagram illustrating a reflection characteristic modeling result of vehicles corresponding to a medium-sized passenger car and a mean reflection characteristic modeling result of a medium-sized passenger vehicle according to an embodiment.

Referring to FIG. 2, the class reflection characteristic extractor 1310 may include a radar signal simulation generator 1311, a moving object reflection characteristic modeling unit 1317, and/or a class reflection characteristic modeling unit 1319.

The radar signal simulation generator 1311 may include a radar simulation signal generator 1313 and/or a radar signal processor 1315.

The radar simulation signal generation unit 1313 may simulate radar reflection signal data of an object for each class (or type) based on an identification target CAD file.

For example, the radar simulation signal generator 1313 may use each of 3D CAD models of a first moving object #1, of a second moving object #2, . . . and/or of a nth moving object #n in a class as input data to output S-parameters, which are simulation signal data for each moving object. For example, the S-parameters may be parameters indicating frequency input/output relationship of transmission and/or reception signals for each frequency.

The radar signal processing unit 1315 may output reflection signal data for each moving object based on the S-parameters, which are simulation signal data for each moving object.

For example, the radar signal processing unit 1315 may extract and output intensities of the reflection signal data on relative distance and angle plane for each moving object from a radar data cube generated by applying Fast Fourier Transform (FFT) to relative distance-Doppler-angle direction from the S-parameters for each moving object.

The moving object reflection characteristic modeling unit 1317 may approximate reflection signal data for each moving object to a mixed normal distribution, for example, a GMM, and may extract a reflection characteristic for each moving object.

For example, since the radar reflection signal data has a peak shape around the plurality of main reflection points, the moving object reflection characteristic modeling unit 1317 may approximate the radar reflection signal data to a GMM defined by a weighted sum of normal distributions as in Equation 1 below. For an approximation, a VGMM (Variational Gaussian Mixture Model), an optimization, and/or a learning-based technique may be used.

$$\vert 𝒢 = {\sum }_{\text{?} = 1}^{M} π \text{?} \cdot 𝒩 ( x ; μ \text{?} , P \text{?} ) \qquad [ Equation 1 ]$$

$${\begin{matrix}( 𝒩 ( x ; μ \text{?} , P \text{?} ) {=}^{Δ} {e}^{- \text{?} {( x - {μ}_{i} )}^{T} {p}_{i}^{-} ( x - {μ}_{i} )} / C , & C = {( 2 π )}^{\text{?}} \vert {P}_{i} \vert\end{matrix}}^{\text{?}} , … x ∈ {ℝ}^{D}$$

$$\text{?} \text{indicates text missing or illegible when filed}$$

(x: observed value (also referred to input data), M: number of normal distributions (modes) constituting the GMM, πₗ: a weight value of a lth normal distribution, μₗ an average of the Ith normal distribution, Pₗ: variance of the Ith normal distribution, an D: an observed value dimension number)

Referring to FIG. 3, the moving object reflection characteristic modeling unit 1317 may output a result obtained by approximating simulated reflection signal data output from the radar signal processing unit 1315 as shown in FIG. 3A to a GMM corresponding to a reflection characteristic as shown in FIG. 3B.

Meanwhile, the reflection signal data may vary according to a relative geometric, for example, a relative distance and/or an observation angle, between the radar and the object.

When the radar 15 and the object have the same lateral angle, the moving object reflection characteristic modeling unit 1317 may approximate the reflection characteristic of the long-distance moving object based on the reflection characteristic of the moving object extracted from the reference distance and the resolution of the radar 15. Therefore, the moving object reflection characteristic modeling unit 1317 may change the lateral angle with respect to the reference distance and extract the reflection characteristic of the moving object to reduce the burden of the database construction.

When the intensity of the reflection signal is approximated to the GMM like the operation method of the moving object reflection characteristics modeling unit 1317 described above, the following advantages may be obtained as compared with the conventional art.

### Advantage:

1. Reducing the weight of a database and convenience in its construction;
1-1. The intensity of a reflected signal for a distance and/or azimuth cell can be described only with a GMM parameter (weight, average and/or variance).
1-2. It can correspond to a radar with various distance and/or angle resolutions through inter-mode coalescing that configures the GMM.
2. Ease of performance analysis;
2-1. The probability characteristics of the obtained detection information can be analytically evaluated by describing the intensity characteristics of the reflected signal in GMM. This allows to quantitatively determine from which class the obtained detection information originated.

The class reflection characteristic modeling unit 1319 may model an average reflection characteristic of objects existing in the same class having a similar shape and/or size based on the reflection characteristic for each moving object.

Referring to FIG. 4, the class reflection characteristic modeling unit 1319 may model and output the average reflection characteristic of the mid-sized passenger vehicle as shown in FIG. 4C in response to receiving, from the moving object reflection characteristic modeling unit 1317, a result that the total width (width) of a shape as shown in of FIG. 4A is 1800 [unit: mm] and the overall length is 4140 [unit: mm] as the reflection characteristic of the vehicle A corresponding to the mid-sized passenger vehicle, and a result that the total width of a shape as shown in of FIG. 4B is 1810 [unit: mm] and the overall length is 4250 [unit: mm] as the reflection characteristic of the vehicle B corresponding to the mid-sized passenger vehicle.

It is virtually impossible to model the reflection characteristics of all objects in the environment in which the vehicle 1 is driving. Accordingly, the class reflection characteristic modeling unit 1319 according to an embodiment of the present disclosure may define classes by grouping objects having similar reflection characteristics, and may make a database of average reflection characteristics for each class.

For example, the class reflection characteristic modeling unit 1319 may classify the classes into a two-wheeled vehicle, a passenger vehicle, and/or a commercial vehicle according to the shape and size of the reflection characteristic approximated by the GMM, and in the case of a passenger vehicle and/or a commercial vehicle, the classes may be subdivided according to the size.

The class reflection characteristic modeling unit 1319 may store the modeled class reflection characteristic in a class reflection characteristic database (DB) 1201 of the memory 120.

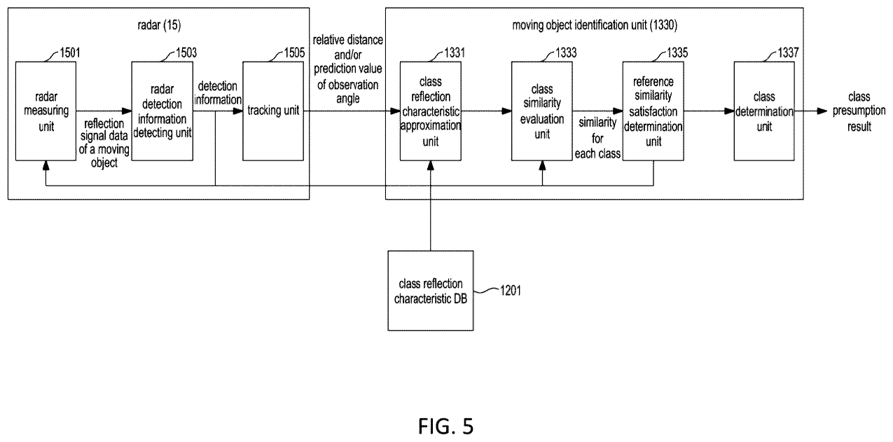

FIG. 5 is a block diagram illustrating a detailed feature of the radar 15 and the moving object recognizing unit 1330 according to the embodiment of FIG. 1.

Referring to FIG. 5, the moving object recognizing unit 1330 may determine and output a type of a moving object, that is, a class estimation result of the moving object, based on information output from the radar 15 and information stored in the class reflection characteristic database 1201.

The radar 15 may include a radar measuring unit 1501, a radar detection information detecting unit 1503, and/or a tracking unit 1505.

The radar measurement unit 1501 may obtain a reflection signal of a moving object corresponding to an identification target.

For example, the radar measuring unit 1501 may obtain data, that is, a data cube in the relative distance, the gaze angle, and the Doppler space (also expressed as the relative distance-gaze angle-Doppler space) at each time point.

The physical properties of the data cube mean a spatial distribution of the strength of a received signal that is reflected and returned from an object, that is, a reflected signal.

The radar detection information detection unit 1503 obtains a Range Doppler Image (RDI) corresponding to a reflection signal intensity defined on the relative distance and of the data cube and Doppler space plane (also referred to as a relative distance-Doppler space plane), as the detection information, based on the radar reception signal obtained through the radar measurement unit 1501.

The radar detection information detection unit 1503 may obtain the distance and/or Doppler information of the moving object by applying a predetermined detection logic such as a Constant False Alarm Rate (CFAR) to the RDI, and then detect (also referred to as extraction) detection information corresponding to the gaze angle information corresponding to the distance and/or Doppler information. The detection information refers to information capable of checking the position of the moving object, such as an angle and/or a relative distance.

The tracking unit 1505 may obtain information (also referred to as a predicted value of an observation angle) on the relative geometry, that is, the relative distance and/or the observation angle between the radar 15 and the moving object based on a tracking logic.

In general, a tracking logic for predicting a position and/or a speed of a moving object is embedded in the radar 15, and accordingly, the tracking unit 1505 may determine the relative geometry of the moving object based on the tracking logic.

The moving object identification unit 1330 may include a class reflection characteristic approximation unit 1331, a class similarity evaluation unit 1333, a reference similarity satisfaction determination unit 1335, and/or a class determination unit 1337.

In order to reduce a burden of reflection characteristic modeling, the class reflection characteristic approximation unit 1331 may locate an object at a predetermined reference distance and then extract and model a reflection signal.

The class reflection characteristic approximation unit 1331 may extract a model at a predetermined reference distance by applying a relative geometry to a reference distance reflection signal model and thus approximating the reference distance reflection signal model because the characteristic of reflection signal data varies according to the relative geometry.

In addition, when applying the relative geometry to all radar points corresponding to the reflected signal data, the class reflection characteristic approximation unit 1331 may extract a model at a predetermined reference distance by additionally applying a predetermined radar distance and an angular resolution of the radar 15 with the relative geometry to the reference distance reflection signal model to approximate the reference distance reflection signal model in consideration of a problem such as an increase in the amount of computation of the processor 130.

For example, the class reflection characteristic approximation unit 1331 may approximate the reflection characteristic of the predetermined reference distance of the moving object by applying the relative geometry to representative points of the radar points corresponding to the reflection signal through the reference distance reflection signal model and applying the radar distance and the angular resolution to the remaining points.

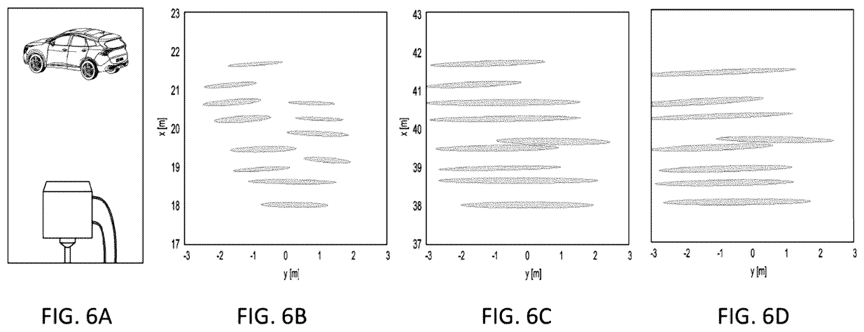

FIG. 6 is a diagram for describing accuracy of an output of the class reflection characteristic approximation unit 1331 according to an embodiment.

Referring to FIG. 6, as illustrated in FIG. 6A, an actual reflection characteristic obtained through an actual experiment on a vehicle corresponding to an object positioned at a point where a distance from the radar 15 is 20 [m] may have a shape as illustrated in FIG. 6B. When the class reflection characteristics approximation unit 1331 approximates the reflection characteristics of the object located at 40 [m] using FIG. 6B, the shape as shown in FIG. 6C may be modeled. FIG. 6d illustrates a shape of an actual reflection characteristic obtained through an actual experiment on a vehicle corresponding to an object positioned at a point at which a distance from the radar 15 is 40 [m]. When FIG. 6C is compared with FIG. 6D, it can be seen that the similarity between two reflection characteristics is high.

As a reference, rough relative geometric (i.e., relative distance and/or angle of view) information between the radar 15 and the object may be provided by the tracking logic embedded in the radar 15.

The class similarity evaluation unit 1333 may determine class similarity for the detection information detected by the radar detection information detection unit 1503 by using the reflection characteristics for each class approximated by the class reflection characteristic approximation unit 1331 as probability distribution for the appearance frequency and location of the detection information.

For example, the class similarity evaluator 1333 may apply the obtained weight, average, and variance of the reflection characteristics and the obtained detection information to a mixed normal distribution model (e.g., GMM) to determine similarity between the obtained reflection characteristics and each of the classes.

In an embodiment of the present disclosure, an average of the reflection characteristic values at the position of the object to be identified may be regarded as the similarity based on the detected detection information. Accordingly, the class similarity evaluator 1333 may calculate an average of reflection characteristics at the position of the target object to be identified based on the detected detection information, and determine the calculated average as the similarity.

For example, when a total of N pieces of detection information x are detected by the radar detection information detection unit 1503, the similarity between the object to be identified and the i-th class Ci may be determined through Equation 2 below.

$$P ( {C}_{i} ) = \frac{1}{N} {\sum }_{j = 1}^{N} {𝒢}_{i} ( {x}_{j} ) \qquad [ Equation 2 ]$$

$${𝒢}_{i} ( {x}_{j} ) = {\sum }_{i = 1}^{{M}_{j}} π \text{?} \cdot 𝒩 ( {x}_{j} ; μ \text{?} , P \text{?} ) , \qquad {𝒢}_{i} ( \cdot )$$

$$\text{?} \text{indicates text missing or illegible when filed}$$

[symbol]

ᵢ(·): reflection characteristics of I-th Class Ci modeled by GMM, πᵢ^{l}: a weight value of the obtained reflection characteristics, [symbol] (x;μ,P): a function value in a normal distribution where an average and a variance of the obtained reflection characteristics are μ, P each, x: detection information

The class similarity evaluation unit 1333 may perform similarity normalization through a conventional normalization technique in order to select a reference similarity in the reference similarity satisfaction determination unit 1335 to be described later. For example, the class similarity evaluation unit 1333 may perform similarity normalization through Equation 3 below.

### [Equation 3]

$$\overline{P} ( C \text{?} ) = P ( C \text{?} ) / {\sum }_{j = 1}^{{N}_{C}} P ( {C}_{j} )$$

$$\text{?} \text{indicates text missing or illegible when filed}$$

(P̅(Cᵢ): Similarity normalization result P̅(Cᵢ): P̅(Cᵢ) in Equation 2, Nc: number of classes previously modeled)

In the similarity normalization process, an object may be identified with the same reference similarity even when the number of radar points obtained at each time point changes.

As described above, the embodiment of the present disclosure for evaluating the similarity based on the reflection characteristics and the detection information of the class approximated by the mixed normal distribution has various effects such as reduction of data required for learning, reduction of a burden of a calculation amount of an object identification process, and easy quantitative evaluation and analysis of object identification performance, compared to the conventional art.

The reference similarity satisfaction determination unit 1335 may determine whether the reference similarity for the similarity for each class, which is the output result of the class similarity evaluation unit 1333, is satisfied, based on a SPRT (Sequential Probability Ratio Test).

When the similarity (also referred to as cumulative similarity) determined by the class similarity evaluation unit 1333 is equal to or less than a predetermined threshold value, the reference similarity satisfaction determination unit 1335 may provide a related signal to the radar measurement unit 1501 so as to suspend class determination by the class determination unit 1337 to be described later and re-measure the reflection characteristic of the identification object.

When the cumulative similarity determined by the class similarity evaluation unit 1333 exceeds a predetermined threshold value, the reference similarity satisfaction determination unit 1335 may provide a signal to the class determination unit 1337 so that the class determination unit 1337 determines the class of the object.

The class determining unit 1337 may determine a class having the highest similarity among similarities for each class, which is the output result of the class similarity evaluating unit 1333, as a class of an object and output information of an object (also referred to as a type of an object) corresponding to the class.

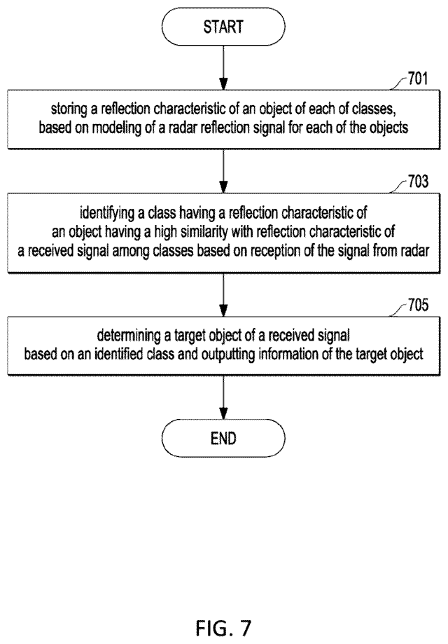

FIG. 7 is a flowchart of an operation of the object identification apparatus 100 (and/or the processor 130) according to an embodiment.

Referring to FIG. 7, in operation 701, the object recognizing apparatus 100 may store a reflection characteristic of an object of each of classes obtained by classifying objects of each of classes obtained by classifying the objects according to sizes, based on modeling of a radar reflection signal for each of the objects.

For example, the object recognizing apparatus 100 may generate a radar reflection signal through a radar simulation signal generator.

In addition, the object recognizing apparatus 100 may perform fast Fourier transform on the radar reflection signal for each of the objects, and accordingly, may extract the intensity of the radar reflection signal on the relative distance and the angle plane from the generated radar data cube.

In addition, the object recognizing apparatus 100 may model the intensity of the radar reflection signal for each of the objects as the mixed normal distribution.

For example, the classes may correspond to the types of vehicles, such as a class corresponding to a two-wheeled vehicle, a class corresponding to a passenger vehicle, and/or a class corresponding to a commercial vehicle.

In addition, each of the class corresponding to the passenger vehicle and/or the class corresponding to the commercial car may include a class corresponding to each of predetermined object sizes.

The object recognizing apparatus 100 may identify a class having a reflection characteristic of an object having a high similarity with the reflection characteristic of the received signal data among the classes based on the reception of the signal from the radar 15 (703).

For example, the object recognizing apparatus 100 may apply the signal data received from the radar 15 to the radar reflection characteristic model to obtain the reflection characteristic of the target object at the designated reference distance of the radar reflection characteristic model. In more detail, when the signal data received from the radar 15 is applied to the radar reflection characteristic model, the object recognizing apparatus 100 may apply information indicating a relative distance and an observation angle between the radar 15 and the target object and a predetermined radar distance and angle resolution of the radar 15 to the radar reflection characteristic model to obtain the reflection characteristic of the target object at a designated reference distance of the radar reflection characteristic model.

In addition, the object recognizing apparatus 100 may previously define classes by grouping objects having similar reflection characteristics, and may determine an average reflection characteristic for each class. Based on this, the object identification apparatus 100 may determine the similarity between the identification target object and the class from the radar detection information generated by the identification target object.

For example, a reflection characteristic value corresponding to each of the detection information obtained by the radar may be obtained from the reflection characteristic model approximated by the mixed normal distribution, and the average of the corresponding values may be defined as the similarity.

Further, the total number of identification target classes is previously defined and known information, and each class similarity may be redefined as a reference similarity through normalization.

In addition, the object recognizing apparatus 100 may identify a class in which a reference similarity accumulated over time exceeds a threshold value using a statistical technique of values obtained and accumulated from a plurality of scan data as a concept of a SPRT (sequential probability ratio test), and identify a class having a reflection characteristic of an object having a high similarity among classes in which the reference similarity exceeds the threshold value.

In operation 705, the object recognizing apparatus 100 may determine a target object of the received signal data based on the identified class and output information of the target object.

Hereinafter, a result of performing an actual experiment on the object identification technology according to an embodiment of the present disclosure described above will be described.

In order to verify the performance of the object identification technology of the present disclosure, an object identification experiment was performed on a vehicle corresponding to a mid-sized passenger vehicle in the class of the object through a high-resolution radar having a performance of about a distance resolution 5 [cm] and a horizontal angle resolution 1 [deg].

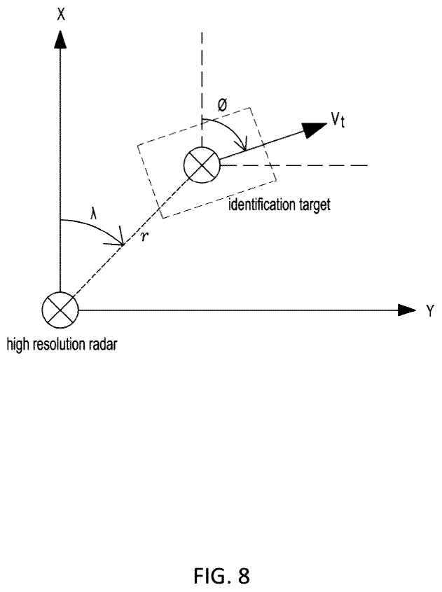

In the object identification experiment, in order to identify a change in object identification performance according to a relative geometry between the high resolution radar and the vehicle to be identified, reflection signals for the actual vehicle were obtained at various relative distances and/or observation angles as shown in Table 1 below in a defined coordinate system as shown in FIG. 8.

FIG. 8 is a coordinate system defining the relative geometry between the high-resolution radar and the object to be identified.

TABLE 1

| Relative distance | Heading | Observation |
|---|---|---|
| (r)/(λ) Viewing angle | angle (ϕ) | angle (L) |
| 1) In first case: | 0[deg] | 0[deg] |
| 7.5[m]/0[deg] | −15[deg] | 15[deg] |
| 2) In second case: | −30[deg] | 30[deg] |
| 15.0[m]/0[deg] | −45[deg] | 45[deg] |
| | −60[deg] | 60[deg] |
| | −75[deg] | 75[deg] |
| | −90[deg] | 90[deg] |

The observation angle L may be defined as a difference (L=λ−ϕ) between a gaze angle (λ) and a heading angle (λ) in FIG. 8.

In addition, in the object identification experiment, the vehicle was positioned (λ=0 [deg]) in front of the radar to verify the performance of the object identification technology of the present disclosure, and the heading angle L was changed, so that the pipe angle L was defined as the same size as the heading angle (ϕ) but the opposite sign((L=−ϕ).

Also, in the object identification experiment, a similarity evaluation was performed by comparing the detection information of the actual identification target detected from the high resolution radar and the reflection characteristics for each class. The similarity with the specific class is determined through normalization after adding all the GMM function values at the position where the object corresponding to the detection information is located, as in the above-described embodiment.

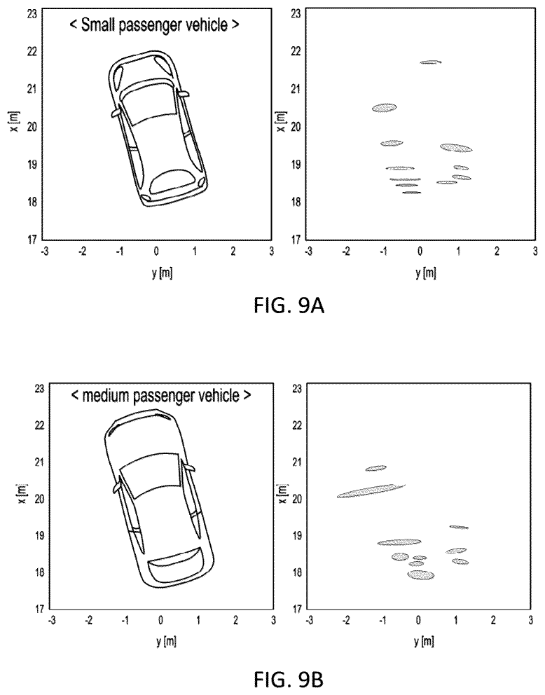

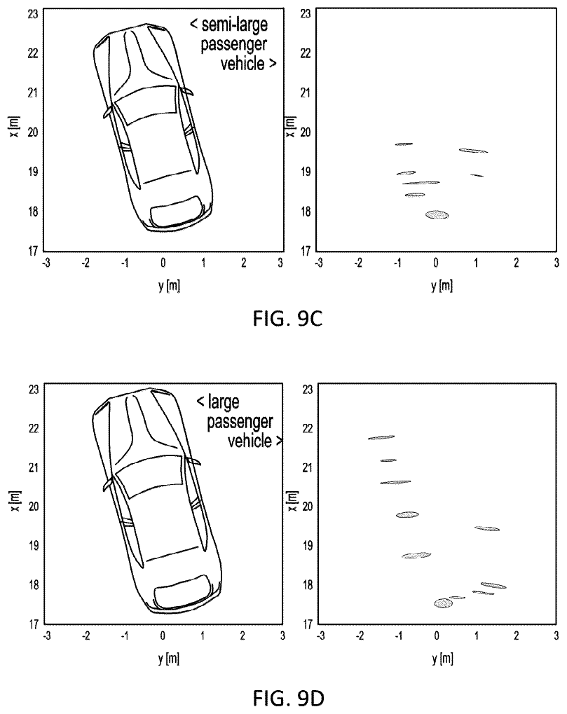

FIG. 9 is a diagram illustrating an output result of reflection characteristics for each class according to an object identification experiment according to an embodiment.

In the object identification experiment, in order to evaluate the usefulness of the object identification technology according to the above-described embodiment, normalized similarity P̅(Cᵢ) with respect to the reflection characteristics for each class of FIG. 9 was calculated.

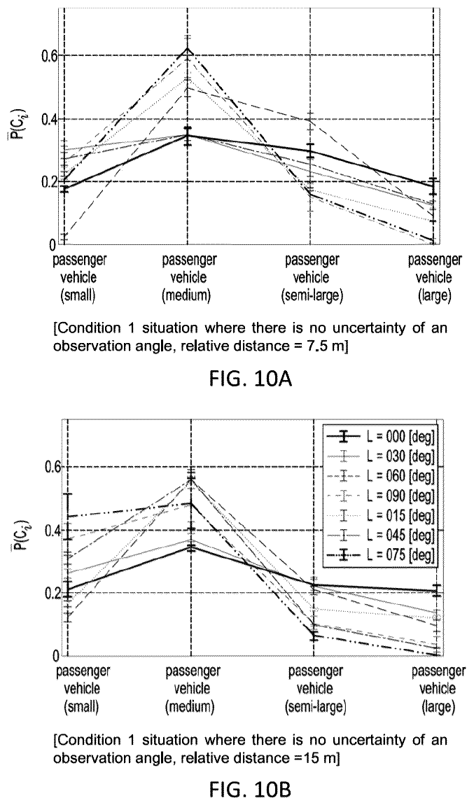

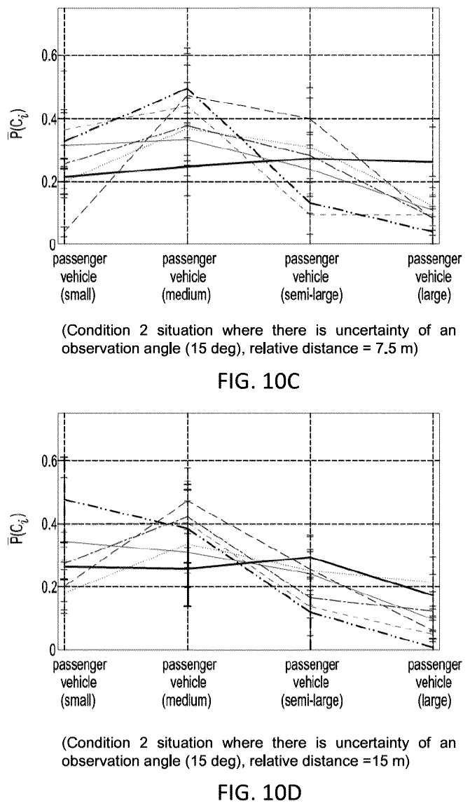

In order to statistically analyze the performance of the object identification technology according to the above-described embodiment, an average and a standard deviation of normalized similarity are derived through 200 data measurements for each relative geometry, as shown in FIG. 10.

FIG. 10 illustrates a graph showing the normalized similarity P̅(Cᵢ) for each class (small passenger car, medium-sized passenger vehicle, semi-large passenger vehicle, and large passenger vehicle) according to an object identification experiment.

The center of the error bar graph in FIG. 10A and FIG. 10B denotes an average of P̅(Cᵢ) and the bar length denotes a standard deviation ±1σ value.

FIG. 10A illustrates a graph showing normalized similarity P̅(Cᵢ) for each class (a small passenger vehicle, a medium passenger vehicle, a semi-large passenger vehicle, and a large passenger vehicle) when a relative distance is 7.5[m] in a situation in which there is no uncertainty of an observation angle of an identification target object, that is, the observation angle of an identification target object is accurately known.

FIG. 10B is a graph illustrating normalized similarity P̅(Cᵢ) for each class (small passenger vehicle, medium passenger vehicle, semi-large passenger vehicle, and large passenger vehicle) when a relative distance is 15[m] in a situation where there is no uncertainty of an observation angle of an identification target.

FIG. 10C is a graph illustrating normalized similarity P̅(Cᵢ) for each class (a small passenger vehicle, a medium-sized passenger vehicle, a semi-large passenger vehicle, and a large passenger vehicle) when a relative distance is 7.5[m] in a situation where there is uncertainty of an observation angle of an object to be identified around 15[deg].

FIG. 10D is a graph illustrating normalized similarity P̅(Cᵢ) for each class (a small passenger vehicle, a medium-sized passenger vehicle, a semi-large passenger vehicle, and a large passenger vehicle) when a relative distance is 15[m] in a situation where there is uncertainty of an observation angle of an object to be identified around 15[deg].

Referring to FIG. 10A and FIG. 10B, it can be seen that in a situation in which the observation angle of the identification target is accurately known, the similarity to the actual class (medium-sized passenger vehicle) of the identification target is highest regardless of the relative geometry. However, it can be seen that the similarity values of the actual classes are different each other for each observation angle, and thus the identification performance is changed for each observation angle.

Referring to FIG. 10C and FIG. 10D, it can be seen that even in a situation where there is uncertainty in the observation angle of the identification target, a correct result having the highest similarity to the actual class (medium-sized passenger vehicle) of the identification target is output. In the case where the observation angle L is 0 [deg], that is, in the case where the rear surface of the vehicle is observed, a misidentification may occur, but performance may be supplemented by using the reflection characteristic accumulated for each time point.

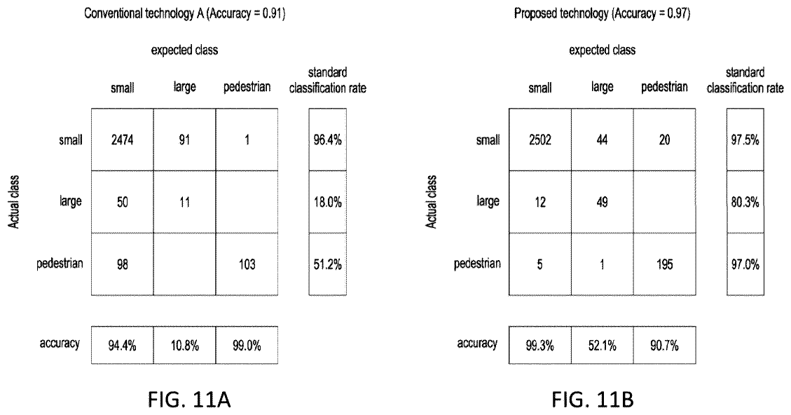

FIG. 11 is a diagram illustrating classification performance of a conventional technology and an object identification technology according to an embodiment of the present disclosure, in a confusion matrix.

In order to evaluate the usefulness of the performance (also referred to as classification performance) of the object identification technology according to an embodiment of the present disclosure, performance verification for the RADIATE Dataset provided by the Heriot-Watt University was performed.

The conventional image processing (or Faster R-CNN) and the object identification technology according to an embodiment of the present disclosure are applied to 2,566 passenger vehicles, 61 large vehicles, and 202 pedestrians in an urban situation.

On the assumption that the vehicle detection is successful, the classification performance of the conventional technology for the detected vehicle and the object identification technology according to the embodiment of the present disclosure to the detected vehicle are shown in FIG. 10.

FIG. 11A illustrates the classification performance of the object identification technology according to the conventional art as a confusion matrix, and FIG. 11B illustrates the classification performance of the object identification technology according to an embodiment of the present disclosure as a confusion matrix.

Comparing FIG. 11A with FIG. 11B, it can be seen that the accuracy of the object identification technology according to an embodiment of the present disclosure is improved by about 6%, compared to the conventional art.

In particular, in the case of a large vehicle, it can be seen that the standard classification rate and the accuracy of the object identification technology according to an embodiment of the present disclosure are greatly improved by 62.3% and 41.3%, respectively, compared to the conventional art.

The above-described embodiments may be implemented in the form of a recording medium for storing instructions executable by a computer. The instructions may be stored in the form of program code, and when executed by a processor, the instructions may be executed by generating a program module operations of the examples may be performed. The recording medium may be implemented as a computer-readable recording medium.

The computer-readable recording medium includes all types of recording media in which computer-readable instructions are stored. For example, there may be a Read Only Memory (ROM), a Random Access Memory (RAM), a magnetic tape, a magnetic disk, a flash memory, an optical data storage device, etc.

The embodiments disclosed above have been described with reference to the accompanying drawings. It will be understood by those skilled in the art that the present disclosure may be implemented in a different form from the disclosed embodiments without changing the technical idea or essential feature of the present disclosure. The disclosed embodiments are illustrative and should not be construed as limiting.

What is claimed is:

1. A method for recognizing an object, the method comprising:
storing a reference reflection characteristic for each of classes based on modeling radar reflection signal data for each of objects corresponding to each of the classes;
determining, among the classes, a class of a reference reflection characteristic of a high similarity with a reflection characteristic of received signal data transmitted from a radar; and
identifying a target object of the received signal data based on the determined class and outputting information of the target object.

2. The method of claim 1, wherein the modeling the radar reflection signal data for each of objects comprises modeling an intensity of the radar reflection signal data into a mixed normal distribution.

3. The method of claim 2, wherein the intensity of the radar reflection signal data includes an intensity of the radar reflection signal on relative distance and angle plane extracted from a radar data cube generated based on Fast Fourier Transform of the radar reflection signal data.

4. The method of claim 1, wherein the radar reflection signal data is generated by a radar simulation signal generator.

5. The method of claim 1, wherein the classes include one or more classes selected from a class corresponding to a two-wheeled vehicle, a class corresponding to a passenger vehicle, and a class corresponding to a commercial vehicle.

6. The method of claim 5, wherein the class corresponding to the passenger vehicle and the class corresponding to the commercial vehicle each includes a class corresponding to each of predetermined object sizes.

7. The method of claim 1, wherein the determining the class includes:
applying the received signal data to a radar reflection characteristic model and obtaining the reflection characteristic with respect to a predetermined reference distance, and determining a similarity between the reference reflection characteristic for each of the classes and the reflection characteristic of the received signal data.

8. The method of claim 7, further comprising:
obtaining, from the radar, information indicating a relative distance and an observation angle between the radar and the target object,
wherein the obtaining the reflection characteristic with respect to the predetermined reference distance comprises:
when applying the received data to the radar reflection characteristic model, applying the information indicating the relative distance and the observation angle to the radar reflection characteristic model.

9. The method of claim 8, wherein obtaining the reflection characteristic with respect to the predetermined reference distance further comprises:
when applying the received data to the radar reflection characteristic model, applying a predetermined radar distance and a predetermined angular resolution of the radar to the radar reflection characteristic model.

10. The method of claim 7, further comprising:
obtaining detection information for determining location information of each of the objects from the radar, wherein the similarity is based on the detection information.

11. The method of claim 10, wherein the determining the similarity comprises:
applying a weight, an average and a variance of the reflection characteristic of the received signal data and the detection information to a mixed normal distribution model to determine the similarity between the reference reflection characteristic for each of the classes and the reflection characteristic of the received signal data.

12. The method of claim 11, further comprising:
determining a reference similarity for each of the classes by normalizing the similarity based on a number of the classes.

13. The method of claim 12, wherein the determining the class comprises:
identifying one or more classes having the reference similarity exceeding a threshold value among the classes, and identifying a class having a highest similarity among the identified one or more classes as the class of the reference reflection characteristic of the high similarity with the reflection characteristic of the received signal data transmitted from the radar.

14. An apparatus for recognizing an object, the apparatus comprising:
a memory configured to store a reference reflection characteristic for each of classes based on modeling radar reflection signal data for each of objects corresponding to each of the classes; and
a processor configured to determine, among the classes, a class of a reference reflection characteristic of a high similarity with a reflection characteristic of received signal data transmitted from a radar, identify a target object of the received signal data based on the determined class, and output information of the target object.

15. The apparatus of claim 14, wherein the modeling the radar reflection signal data for each of objects include modeling an intensity of the radar reflection signal data into a mixed normal distribution.

16. The apparatus of claim 15, wherein the intensity of the radar reflection signal data includes an intensity of the radar reflection signal on relative distance and angle plane extracted from a radar data cube generated based on Fast Fourier Transform of the radar reflection signal data.

17. The apparatus of claim 14, wherein the radar reflection signal data is generated by a radar simulation signal generator.

18. The apparatus of claim 14, wherein the classes include one or more classes selected from a class corresponding to a two-wheeled vehicle, a class corresponding to a passenger vehicle, and a class corresponding to a commercial vehicle.

19. The apparatus of claim 14, wherein the processor is further configured to obtain the reflection characteristic of the target object with respect to a predetermined reference distance by applying the received signal data to a radar reflection characteristic model, and determine a similarity between the reference reflection characteristic for each of the classes and the reflection characteristic of the received signal data.

20. The apparatus of claim 19, wherein the processor is further configured to obtain information indicating a relative distance and an observation angle between the radar and the target object from the radar, and when applying the received data to the radar reflection characteristic model, the processor is configure to apply the information indicating the relative distance and the observation angle and a predetermined radar distance and a predetermined angle resolution of the radar to the radar reflection characteristic model.
